(19) United States
(12) Patent Application Publication
(10) Pub. No.: US 2009/0271816 A1
(43) Pub. Date: Oct. 29, 2009

(54) METHODS AND SYSTEMS RELATING TO THE IMPORT, MANIPULATION AND EXPORT OF DATA USING SET-TOP BOXES

(75) Inventor: Fabien Marcel Jacques Guillorit, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/303,300

(22) PCT Filed: Jun. 26, 2007
(86) PCT No.: PCT/IB07/52475

§ 371 Date: Dec. 3, 2008

Related U.S. Application Data
(60) Provisional application No. 60/817,460, filed on Jun. 29, 2006.

(51) Int. Cl. H04N 7/167; H04N 7/18; H04N 7/173

(52) U.S. Cl. 725/31; 725/85; 725/81; 725/74; 725/110

(57) ABSTRACT

Methods and devices for exporting and displaying video information are disclosed. For example, an exemplary set-top box specially configured to receive, manipulate and export video signals and television programming information is described. The set-top box includes a tuning device capable of receiving both television signals and programming signals relating to the received television signals, a data extraction device configured to extract programming information from the received programming signals, and a network interface capable of communicating with a network residing in a consumer residence, wherein the data extraction device is further configured to provide the programming information to one or more computer-based devices connected to the network via a data-transmission protocol.

A “Set-Top Box” (STB) is a device that can provide an interface between a cable TV service provider and a consumer's television in order to give the consumer access to various cable TV services. At the most basic level, an STB is a tuner with special controls. Such special controls are designed to allow a consumer to effectively switch channels. Such controls are also designed to enable the service provider to remotely allow or deny consumer access to various channels, as well as provide data security between the cable service provider and various STBs.

Certain cable service providers are also using their cable TV infrastructure to enable consumers to hook up an independent Internet interface/modem to the same cable that provides television services to an STB. Other cable service providers have developed STBs that allow Internet access using the STB, a remote keyboard and respective television in lieu of a personal computer. Still other cable service providers have developed STBs having an Ethernet port to enable a consumer to hook up a personal computer directly to the STB to receive Internet access.

Unfortunately, while the integration of video and non-video services has increased over the years, cable and satellite TV service providers have yet to realize all the practical advantages that may be gained in the interplay of tradition STB functions with other (non-STB) devices. Accordingly, new technology related to the capture, display and manipulation of television programming is desirable.

In a first embodiment, a set-top box specially configured to receive, manipulate and export video signals and television programming information is disclosed. The set-top box includes a tuning device capable of receiving both television signals and programming signals relating to the received television signals, wherein the set-top box is capable of rebroadcasting the received television signals to an external device according to a video-display standard, a data extraction device configured to extract programming information from the received programming signals, the programming information including at least one or more schedules for a plurality of television channels with each schedule identifying one or more programs with respective time-slots upon which the programs are presented or available, and a network interface capable of communicating with a network residing in a consumer residence, wherein the data extraction device is further configured to provide the programming information to one or more computer-based devices connected to the network via a data-transmission protocol.

In a second embodiment, a system for the export of video signals and television programming information includes a television network, a plurality of residential communication networks residing in a plurality of respective residences, wherein each residential communication network is connected to one or more general-purpose computing devices including a first general-purpose computing device capable of receiving and displaying programming information on a primary display, and a video distribution apparatus attached to each residential communication network, the video distribution for extracting video signals and respective programming information from the television network, rebroadcasting the video signals to at least one of a television and a video recording device, and providing the programming information to a respective general-purpose computing device capable of displaying the programming information.

In a third embodiment, a method for the export of video signals and respective programming information includes the steps of receiving from a cable television provider a series of video signals and respective programming information signals, extracting and rebroadcasting the video signals to at least one of a television and a video recording device according to a video-display format, and providing the programming information, via a network operating and according to a data-transmission protocol, to a general-purpose computing device capable of displaying the programming information.

In a fourth embodiment, a television program aggregation device includes a network interface configured to be coupled to a network and further configured to receive programming information from one or more set-top boxes also coupled to the network, and a first device configured to extract programming information from multiple sources including the one or more external set-top boxes, the programming information including at least one or more schedules for a plurality of television channels with each schedule identifying one or more programs with respective time-slots upon which the programs are presented or available, wherein the first device is further configured to aggregate the received programming information.

In a fifth embodiment, a method of aggregating television programming information from at least two set-top boxes coupled to a network includes receiving two or more sets of programming information with each set relating to one of the set-top boxes, the programming information including at least one or more schedules for a plurality of television channels with each schedule identifying one or more programs with respective time-slots upon which the programs are presented or available, and transferring the programming information of at least one set-top box using a first network such that the two or more sets of programming information are aggregated in a common device.

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

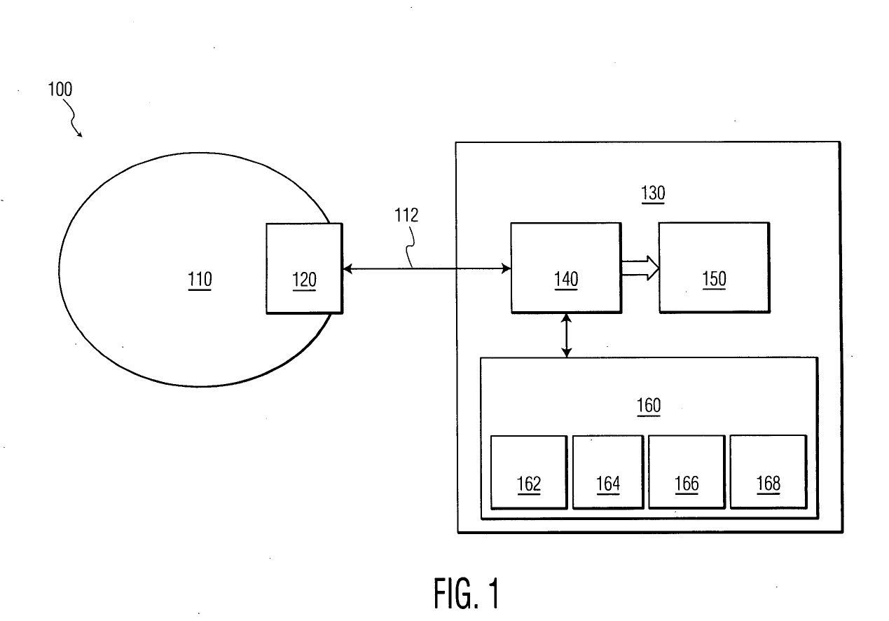

FIG. 1 shows an exemplary television services system for use with the disclosed methods and systems;

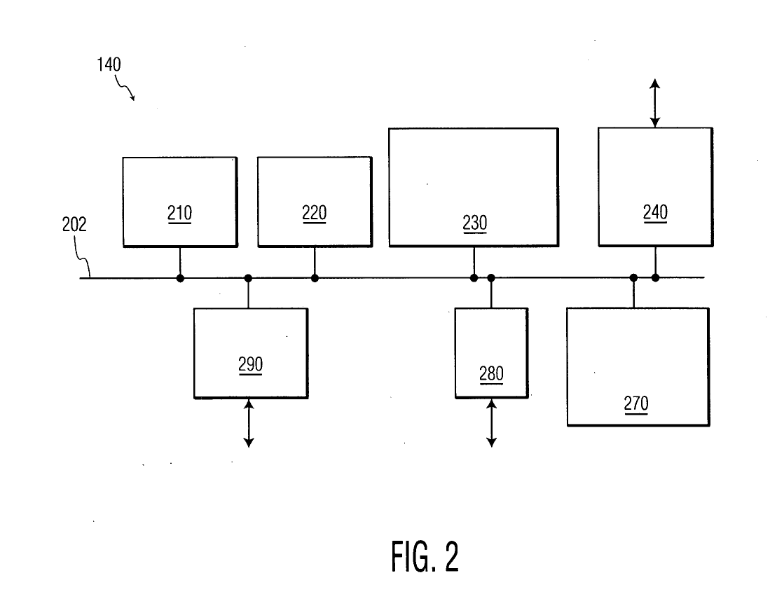

FIG. 2 shows a block diagram of an exemplary set-top box for use in the disclosed methods and systems;

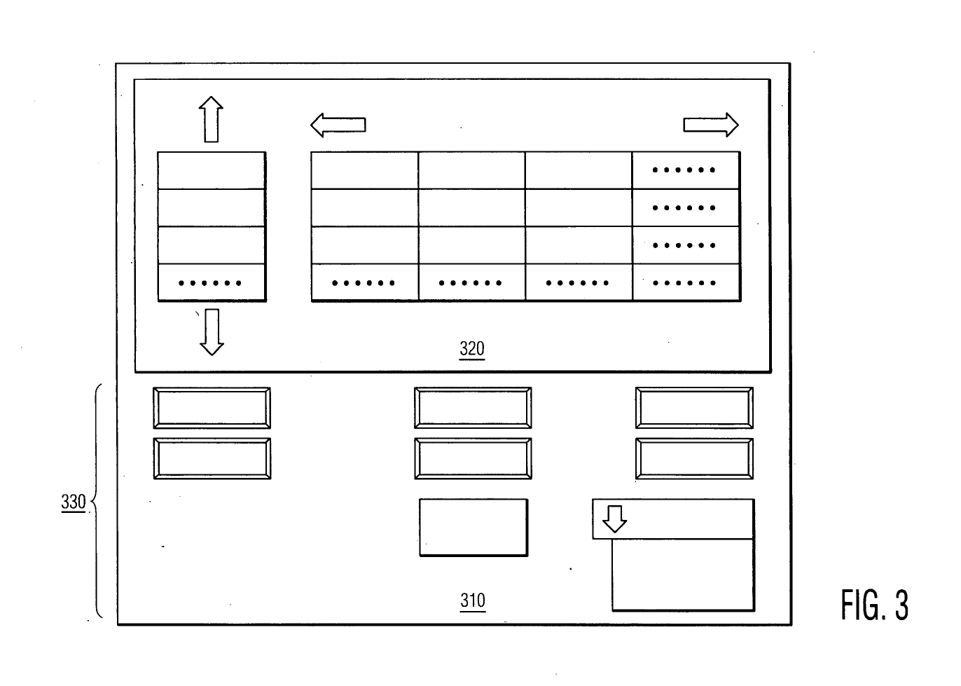

FIG. 3 depicts an exemplary display screen with embedded controls useful for viewing television programming information and receiving various consumer commands; and

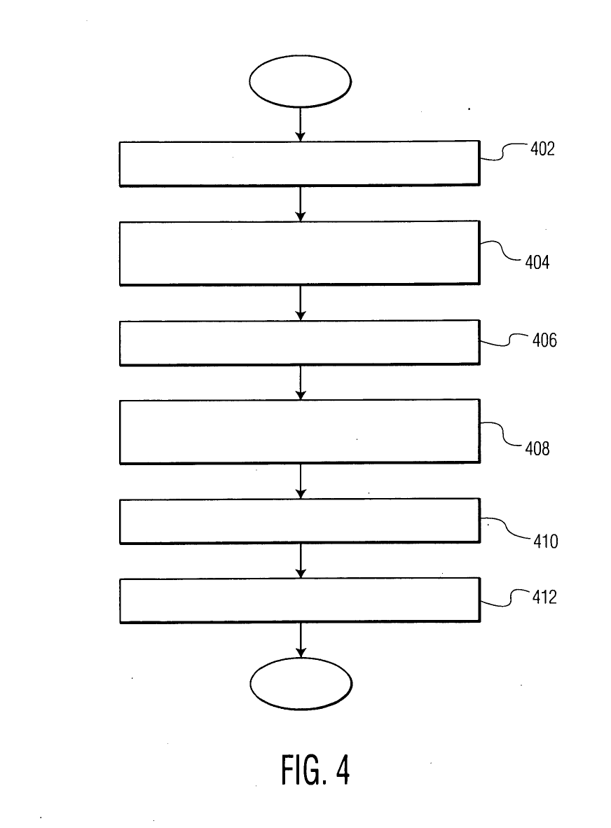

FIG. 4 is a block diagram outlining various exemplary operations directed to the display of video signals and related programming information.

In the following detailed description, for purposes of explanation and not limitation, example embodiments disclosing specific details are set forth in order to provide a thorough understanding of an embodiment according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatus and methods may be omitted so as to not obscure the description of the example embodiments. Such methods and apparatus are clearly within the scope of the present teachings.

FIG. 1 depicts an exemplary television services system 100 according to the disclosed methods and systems. As shown in FIG. 1, the television services system 100 includes a network 110 with an automated agent 120 connected to a set-top box (STB) 140 located in a consumer residence 130 via a link 112. The STB 140 is coupled to a television 150 and to a local network 160, which for the present example includes a general-purpose personal computer (PC) 162, a personal digital assistant (PDA) 164, a digital video disk (DVD) recorder/player 166 and a video-cassette recorder (VCR) 168. The exemplary networked devices 162-168 are communicatively linked via a number of IEEE 802.11 g wireless compliant devices (not shown).

In operation, video signals, e.g., basic television programs and special order video services, can be broadcasts from the network 110 to the STB 140 under control of the agent 120. In addition to the various video services, the agent 120 can provide a host of programming information to the STB 140, which for the present example can include a full or partial list of all programs made available by the network 110, the respective channel and time-slot information for each program, the cost of any specialty program (e.g. Pay-Per-View), narratives/abstracts describing each program, program transcripts, close-captioning information, information describing other services made available via the network 110 and so on.

Once received by the STB 140, the STB 140 can rebroadcast any of the various video signals to the television 150 using any known or later-developed protocols specifically designed for video display, such as NTSC, PALS, HDTV and so on. Additionally, the STB 140 can provide any or all the programming information to the television 150 according to any number of known or later developed schemes whereby a consumer, manually or by using a remote control, can scroll through such information using the television's screen.

Note that, in various alternate embodiments, the STB 140 can be an Internet-based device capable of receiving programming and other information via the Internet as well as television video signals from a television service provider. In similar embodiments, the STB 140 may be capable of receiving both programming information and television video signals via the Internet. In such instances, link 112 may take the form of connections to both to agent 120 and to an Internet-based server (not shown), or possibly to a high-capacity Internet-based server (not shown)

In addition to providing programming information to a consumer via the television 150, the exemplary STB 140 can also provide any or all such programming information to any device 162-168 communicatively coupled to the local network 160.

Further, depending on the nature of the receiving networked device 162-168, certain television-related functions may be performed without using the television 150. For example, a consumer using the PC 162 can order a specific pay-per-view service and optionally record the ordered service using the DVD recorder 166. Additionally, the consumer could optionally program his PDA 164 to send timely reminders that the ordered service is about to commence.

While the exemplary residence 130 is depicted as having a single set-top box 140, it should be appreciated that many households currently have a plurality of set-top boxes servicing a variety of televisions throughout the household. In such instances, the set-top box 140 of FIG. 1 can conceptually be replaced with multiple set-top boxes, and the multiple set-top boxes may have different capabilities and possibly be associated with different service providers.

For example, in a household having three set-top boxes A, B and C, assume that set-top boxes A and B may have two different, but overlapping, sets of available programming even though they're serviced by the same cable television service provider. Further, assume that set-top box C is serviced by a satellite TV provider. Note that any one of the set-top boxes A, B and/or C can be an internet-based set-top box capable of receiving programming and other information via the Internet as described above.

Continuing, each of the three set-top boxes A, B and C can have access to the network 160 to provide their respective programming information to the respective networked devices 162-168. However, rather than burden the consumer with three different databases of programming information, the various sources of programming information alternatively may be combined to form a single database optionally taking into account the overlapping programming information. For instance, assuming that set-top boxes A and B differ only in that set-top box B includes basic service, premium channels and program-on-demand channels while set-top box A has only basic service, a consumer viewing the combined information may desire to view a single programming guide without viewing redundant basic service information.

Still further, assuming that set-top box C includes a different basic service and a different set of program-on-demand channels (having overlapping content and different pricing schedules from set-top box A), the consumer may wish to view a single programming menu omitting any or all redundant basic services, the set of premium channels from set-top box B, and an amalgam of program-on-demand channel information from set-top boxes B and C showing any, all or no redundancy and possibly showing competing prices.

In various embodiments, the aggregation of programming information may be accomplished by any of the networked device 162-168 coupled to the set-top boxes A, B and C. However, in other embodiments, it can be advantageous to enable one of the set-top boxes A, B and C to perform the aggregation of programming information as well as possibly any filtering (to remove redundant data) the formatting that might be useful.

As mentioned above, the exemplary local network 160 is an IEEE 802.11 g wireless interface. However, in other embodiments the exemplary local network 160 can be any viable combination of devices and systems capable of linking computer-based systems including a wide area network, a local area network, a connection over an intranet or extranet, a connection over any number of distributed processing networks or systems, a virtual private network, the Internet, a private network, a public network, a value-added network, an intranet, an extranet, an Ethernet-based system, a Firewire system, a Universal Serial Bus (USB), a Token Ring, a Fiber Distributed Datalink Interface (FDDI), an Asynchronous Transfer Mode (ATM) based system, a telephony-based system including T1 and E1 devices, a wired system, an optical system, a wireless system and so on.

While the exemplary local network 160 uses a well-defined (IEEE 802.11) data-packet oriented protocol, it should be appreciated that any data-oriented protocol, i.e., a protocol not specialized for video or audio reception, capable of transmitting general information and commands can alternatively be used, such as Ethernet, TCP/IP and UDP protocols.

FIG. 2 depicts a block diagram of an exemplary set-top box 140 for use with the disclosed methods and systems. As shown in FIG. 2, the set-top box 140 includes a controller 210, a memory 220, a data extraction and formatting device 230, a network interface 240, a video decryption and video formatting device 270, a video driver 280 and a tuner 290.

Although the exemplary set-top box 140 of FIG. 2 uses a bussed architecture, it should be appreciated that any other architecture may be used as is well known to those of ordinary skill in the art. For example, in various embodiments, the various components 210-290 can take the form of separate electronic components coupled together via a series of separate busses or a collection of dedicated logic arranged in a highly specialized architecture.

It also should be appreciated that some of the above-listed components 230-290 can take the form of software/firmware routines residing in memory 220 and be capable of being executed by the controller 210, or even software/firmware routines residing in separate memories in separate servers/computers being executed by different controllers.

Returning to FIG. 2, operation starts as the controller 210 sets the tuner 290 to receive the video signal of a particular television channel whose signals are broadcast to the set-top box 140 at a predetermined frequency. Depending on the nature of the video signal (i.e., analog versus digital, encrypted or not encrypted, basic service or special, etc), the video signal may be “mixed down” to an appropriate broadcast frequency—typically the frequency for channels 3 or 4 in the US—and forwarded to a television or video recording device via the video driver 280. Other video signals may require decryption or reformatting via the decryption/formatting device 270 before being sent to the video driver 280. Still other video signals may be filtered or “trapped” according to special instructions received by the controller 210 from the television service provider of the set-top box 140, and thus denied to the consumer.

In addition to the reception, conditioning and rebroadcasting of video signals, the exemplary set-top box 140 can be used to extract programming information from the received programming signals, format any received programming information using the decryption/formatting device 270, then rebroadcast the formatted information to a television via the video driver 280.

Further, the exemplary set-top box 140 can provide any of its programming information to any number of external devices (including other STBs) via the network interface 240 and a supporting network (not shown). For this operation, the set-top box 140 can extract the appropriate programming information from received programming signals and format the received programming information using the data extraction/formatting device 230. The formatted program information can then be rebroadcast to the appropriate external devices via the network interface 240.

In a first embodiment, programming information can be sent to a general purpose computing device, i.e., a device capable of processing a wide variety of software applications, such as a personal computer or a PDA. For the purpose of this disclosure, PC, PDAs and the like should be distinguished from special-purpose computing devices, such as a cell phone or DVD player designed to perform a limited number of tasks. In variant embodiments, programming information may be sent to the external computing devices automatically and/or periodically according to a pre-arranged scheme, may alternatively be sent upon special command from the external computing device or may be provided by any number of specially developed schemes.

Once program information is received, the general-purpose computing device can use a specially designed software package to display the programming information to a consumer. Consumer control over the specially designed software may be had using any number of real and virtual controls.

However, as an alternative embodiment, the necessary display and command software resident in a PC, PDA etc. may be limited to any number of Internet-compatible browsers. In such instances, the requisite formatting and software controls may be provided by the set-top box 140 in the form of internally-generated HTML script or some other display format possibly compatible with an Internet browser. In such embodiments, the set-top box 140 can mimic an interactive web-site. Note that formatting may be performed internal to the set-top box 140 or by the respective service provider.

As discussed above, there can be instances where multiple set-top boxes are used in a common residence. In such instances, the various boxes may all make their information available to the external computing devices separately, upon which the external computing devices may handle each set-top box independently. However, as discussed above, it can be advantageous to enable the external devices to compile and display a common database of programming information with any redundant programming information optionally removed from any display made available to the consumer.

Alternatively, any or all of the available set-top boxes may be configured to work together to aggregate programming information and compile a common database—again with redundant information being optionally removed.

In instances where a set-top box is used to aggregate programming information, it should be appreciated that the set-top box should be appropriately configured or modified to perform the requisite aggregation. Returning to FIG. 2, the exemplary set-top box 140 can be modified such that its data extraction and formatting device 230 can receive additional programming information from one or more other networked set-top boxes via the network interface 240. Subsequently, the data extraction and formatting device 230 can aggregate the received programming information received via the network interface 240 along with any programming information received from a television service provider via the tuner 290.

Once the programming information is suitably aggregated and formatted, the aggregated/formatted programming information can be exported to an external device via the network interface 240 (again with redundant information being optionally removed) in a manner as described above, or alternatively be displayed directly on a television screen via the video driver 280.

Note that when one or more set-top boxes are used, it may be advantageous or necessary to append some form of identifier, such as a MAC address or other unique identifier, to associate any exported programming information with its respective set-top box in order to assure proper operation of any consumer interface.

FIG. 3 depicts an exemplary display screen 310 capable of being produced by any number of general or special-purpose computing devices using special programs, Internet browsers or some other software interface. As shown in FIG. 3, the display screen 310 includes an information display portion 320 and a command portion 330. For the purpose of simplicity, the exemplary display screen 310 can be regarded as generated by a PC.

In operation, a consumer operating the PC's exemplary display screen 310 can scroll through a list of television channels containing information about various programs and their respective time slots using a mouse/stylus and the virtual up, down left and right arrows embedded in the display portion 320. While the exemplary format shown in the display portion 320 was picked for simplicity and clarity, it should be appreciated that the particular format of display portion 320 may change from embodiment to embodiment as may be found useful or advantageous. For example, for “on-demand” channels, any representation of time-slots may be omitted in favor of some indication of availability of a particular program.

Returning to FIG. 3, a consumer viewing the display portion 320 can select a program using any number of virtual and real controls, e.g., using the virtual scrolling arrows embedded in display portion 320 to navigate and then “clicking” on the desired program. Once a program is selected, the consumer can perform any number of useful tasks using the control portion 330. For the sake of simplicity and clarity the number of command options of the control portion 330 is limited to three command types: remind, order program and record program.

For the present example, the remind command can be evoked by activating the “REMIND” button, upon which the resident PC and/or the respective set-top box can provide timely reminders to the consumer via the display 310, a television screen, via an email message, an automatic phone message etc. on that the selected program will start soon. Activating the “REMOVE” button directly below the “REMIND” button will remove any currently selected program from whatever command buffer supports the remind function.

The order command works in much the same way as the remind command, i.e., it can be evoked by selecting a program in the display portion 310, then activating the “ORDER” button. Once ordered, the program can be removed by selecting the ordered program using the display portion 310, then activating the “REMOVE” button directly below the “ORDER” button. Program ordering commands can be sent to the television services provider via the respective set-top box or via an alternative route, e.g., an internet connection not associated with the set-top box. Pricing information can be displayed using the “COSTS” field.

The record command can similarly enable a particular device controllable from either the resident PC or the set-top box, such as a DVD or VCR with recording capacity, to record a selected program, or alternatively allow recording via a hard-disk, a DVD recorder or some other mass-storage residing on the PC. The record command can be evoked by selecting a program in the display portion 310, then pressing the “RECORD” button upon which time a command buffer residing in any number of places, e.g., the PC, the set-top box, an accessible recording device or even somewhere in the resources available to a television service provider. The record command can be cancelled by activating the “REMOVE” button directly below the “RECORD” button. Device selection can be accomplished using the pull-down window below both the “REMOVE” and “RECORD” buttons.

While FIG. 3 is shown with a single set-top box in mind, it should be appreciated that in various instances where multiple set-top boxes are available to the consumer, the display 310 may need to be modified to reflect any of: (1) a combined programming guide with redundant channel information optionally omitted, (2) possible references to different set-top boxes (aided using different MAC addresses/IDs as discussed above) for various programs, and (3) competing pricing information. Any controls of the control portion 330 may also need to be modified, especially controls related to the recording and ordering of programs.

FIG. 4 is a block diagram outlining various exemplary operations directed to the display of video signals and related programming information. The process starts in step 402 where a set-top box, such as any of the set-top box embodiments described above, can receive various video signals and respective programming information relating to the received video information via some data conduit, such as a coaxial cable. Next, in step 404, certain received video signals can be decrypted (if necessary) and appropriately reformatted (if necessary) and sent to an external device, such as a television, using NTSC, HDTV, PALS or some other video protocol. Control continues to step 406.

In step 406, programming information received in step 402 can be extracted and formatted. As discussed above, formatting by a set-top box may be minimal and limited to simply packetizing the information, or formatting by a set-top box may take more elaborate forms, such as formatting according to an HTML or other Internet-friendly form. Next, in step 408, the formatted program information can be provided to any number of external devices, both general purpose and specific purpose, via any number of networks, such as an Ethernet network, Bluetooth network etc. As described above, any programming information from multiple set-top boxes may be combined (by an STB or other computer-based device) to an amalgam database with redundant information optionally omitted. Further, MAC addresses or other unique identifiers may be appended to programming information to allow for easy association of the programming information to respective set-top boxes. Control continues to step 410.

In step 410, various consumer commands, including any of those commands discussed above with respect to FIG. 3, can be received using one of the external devices of step 408. Next, in step 412, the consumer commands received in step 410 can be appropriately performed using the external device, the set-top box or some other networked device. Control then continues to step 450 where the process stops.

In various embodiments where the above-described systems and/or methods are implemented using a programmable device, such as a computer-based system or programmable logic, it should be appreciated that the above-described systems and methods can be implemented using any of various known or later developed programming languages, such as “C”, “C++”, “FORTRAN”, Pascal”, “VHDL” and the like.

Accordingly, various storage media, such as magnetic computer disks, optical disks, electronic memories and the like, can be prepared that can contain information that can direct a device, such as a computer, to implement the above-described systems and/or methods. Once an appropriate device has access to the information and programs contained on the storage media, the storage media can provide the information and programs to the device, thus enabling the device to perform the above-described systems and/or methods.

For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the individual systems and/or methods described above.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A set-top box specially configured to receive, manipulate and export video signals and television programming information, the set-top box comprising:
a tuning device configured to receive both television signals and programming signals relating to the received television signals, wherein the set-top box is capable of rebroadcasting the received television signals to an external device according to a video-display standard;
a data extraction device configured to extract programming information from the received programming signals, the programming information including at least one or more schedules for a plurality of television channels with each schedule identifying one or more programs with respective time-slots upon which the programs are presented or available; and
a network interface configured to communicate with a network residing in a consumer residence, wherein the data extraction device is further configured to provide the programming information to one or more computer-based devices connected to the network via a data-transmission protocol.

2. The set-top box of claim 1, wherein the set-top box further includes a decryption device configured to decrypt the received video information before rebroadcasting, the decryption device operating according to instructions provided by a cable television provider providing the television signals and programming signals.

3. The set-top box of claim 1, wherein the network interface is a wireless network interface.

4. The set-top box of claim 3, wherein the wireless network interface operates according to at least one of an IEEE 802 protocol and a Bluetooth protocol.

5. The set-top box of claim 1, wherein the network interface is a wired network interface.

6. The set-top box of claim 5, wherein the wired network interface operates according to at least one of an Ethernet protocol, a USB protocol and a Firewire protocol.

7. The set-top box of claim 1, further comprising a first communication network connected to the network interface, wherein one or more general-purpose computing devices are connected to the first communication network including at least a first general-purpose computing device having resident software configured to receive and display the programming information on a respective primary display.

8. The set-top box of claim 7, wherein the resident software is configured to receive a set of first commands from a consumer viewing the displayed programming information, the set of first commands including at least one of a reminder command, a program ordering command and a program record command.

9. The set-top box of claim 7, wherein the resident software is configured to receive a set of record commands from a consumer viewing the displayed programming information, the set of record commands causing the first general-purpose computing device to cause a recording of a consumer-identified program by a recording device.

10. The set-top box of claim 7, wherein the resident software is configured to receive a set of ordering commands from a consumer viewing the displayed programming information, the set of ordering commands causing the set-top box to broadcast a consumer-identified program to a television or video recording device.

11. The set-top box of claim 10, wherein the set-top box is configured to receive the ordering commands from the general-purpose computing device and provide the ordering commands to a television service provider.

12. The set-top box of claim 1, wherein the programming information provided to the one or more computer-based devices connected to the network includes a unique identifier associating the programming information with the set-top box.

13. A system for the export of video signals and television programming information, the system comprising:
a television network;
a plurality of residential communication networks residing in a plurality of respective residences, wherein each residential communication network is connected to one or more general-purpose computing devices including a first general-purpose computing device configured to receive and display programming information on a primary display; and
a video distribution apparatus attached to each residential communication network, the video distribution apparatus adapted to: extract video signals and respective programming information from the television network; rebroadcast the video signals to at least one of a television and a video recording device; and provide the programming information to a respective general-purpose computing device configured to display the programming information.

14. The system of claim 13, wherein at least one video distribution apparatus includes a plurality of separate set-top boxes, and wherein the first general-purpose computing device is capable of displaying programming information from each set-top box.

15. The system of claim 14, wherein the first general-purpose computing device is capable of displaying programming information from each set-top box with at least some redundant programming information of the plurality of separate set-top boxes not displayed.

16. The system of claim 13, further comprising a means for receiving a set of record commands from a consumer viewing displayed programming information at a general-purpose computing device, the set of record commands causing the recording of a consumer-identified program by a recording device.

17. A method for the export of video signals and respective programming information, the method comprising:
receiving from a cable television provider a series of video signals and respective programming information signals;
extracting and rebroadcasting the video signals to at least one of a television and a video recording device according to a video-display format; and
providing the programming information, via a network operating and according to a data-transmission protocol, to a general-purpose computing device configured to display the programming information.

18. The method of claim 17, further comprising broadcasting the series of video signals and respective programming information signals to a single box performing the receiving, extracting and providing steps.

19. The method of claim 17, further comprising receiving a first command from a consumer located at the general-purpose computing device and viewing the programming information, the first command being related to the ordering or recording of a program.

20. The method of claim 17, further comprising removing redundant programming information provided from multiple set-top boxes from a common display database, then displaying the programming information of the common display database.

21. A television program aggregation device, comprising:
a network interface configured to be coupled to a network and further configured to receive programming information from one or more set-top boxes also coupled to the network; and
a first device configured to extract programming information from multiple sources including the one or more external set-top boxes, the programming information including at least one or more schedules for a plurality of television channels with each schedule identifying one or more programs with respective time-slots upon which the programs are presented or available;
wherein the first device is further configured to aggregate the received programming information.

22. The television program aggregation device of claim 21, wherein the aggregation device is a set-top box.

23. The television program aggregation device of claim 22, wherein the aggregation device is further comprises:
a tuning device configured to receive both television signals and programming signals relating to the received television signals, wherein the aggregation device is capable of rebroadcasting the received television signals to an external device according to a video-display standard and wherein the first device also aggregates the programming signals received via the tuning device.

24. The television program aggregation device of claim 21, wherein at least one of the one or more set-top boxes or the program aggregation device is an internet-based system capable of receiving programming information via the Internet.

25. The television program aggregation device of claim 21, wherein the first device is further configured to remove redundant programming information.

26. The television program aggregation device of claim 21, wherein the first device is further configured to format the aggregated programming information into a format suitable for display.

27. The television program aggregation device of claim 21, wherein the first device is further configured to aggregate and format the aggregated programming information into a manner as to provide a display format that includes competing pricing information.

28. A method of aggregating television programming information from at least two set-top boxes coupled to a network, comprising:
receiving two or more sets of programming information with each set relating to one of the set-top boxes, the programming information including at least one or more schedules for a plurality of television channels with each schedule identifying one or more programs with respective time-slots upon which the programs are presented or available; and
transferring the programming information of at least one set-top box using a first network such that the two or more sets of programming information are aggregated in a common device.

29. The method of aggregating television programming of claim 28, wherein the common device is a set-top box.

30. The method of aggregating television programming of claim 29, wherein at least one set of the two or more sets of programming information is received via a second network link available to the common device.

31. The method of aggregating television programming of claim 29, wherein at least one of the set-top boxes is an internet-based system capable of receiving programming information via the Internet.

32. The method of aggregating television programming of claim 29, further comprising removing redundant programming information from the aggregated programming information.

33. The method of aggregating television programming of claim 32, further comprising formatting the aggregated programming information into a format suitable for display.

34. The method of aggregating television programming of claim 33, further comprising providing competing pricing information with the formatted programming information.
